(19) United States
(12) Patent Application Publication
(10) Pub. No.: US 2004/0262234 A1
(43) Pub. Date: Dec. 30, 2004

(54) Desalinization using a moving magnetic field

(76) Inventors: William L. Warren, Stillwater, OK (US); Richard Stoltz, Plano, TX (US); Edward T. Knobbe, Stillwater, OK (US); Robert Taylor, Perkins, OK (US)

Correspondence Address: NEEDLE & ROSENBERG, P.C., SUITE 1000, 999 PEACHTREE STREET, ATLANTA, GA, 30309-3915, US

(21) Appl. No.: 10/301,830

(22) Filed: Jun. 27, 2003

(51) Int. Cl. C02F 1/48

(52) U.S. Cl. 210/748; 210/695

(57) ABSTRACT

A method and apparatus are provided for fluid purification. A charged species is separated from the fluid using, e.g., a Faraday induced motive forces. This approach deionizes any fluid medium (including water).

### CROSS-REFERENCE TO RELATED APPLICATIONS

This application claims priority from commonly assigned U.S. Provisional Application No. 60/336,019 filed in the names of William L. Warren and Richard Stoltz and from a U.S. Provisional Application entitled Applications of an Ion Bridge and a Counter-Flow Current Flow System for use in Water Deionization” filed on Oct. 24, 2002, in the names of Knobbe et al. These applications are incorporated herein by reference.

### BACKGROUND

Quality water is a shared resource that is becoming increasingly scarce in both developed and developing countries. Water purification and desalination are focus areas of preventative defense and environmental security because they not only meet future global water demands, but can be used for humanitarian assistance in water-starved regions.

### SUMMARY

According to exemplary embodiments, technological revolutions in materials, computational fluid dynamics (CFD), and manufacturing applied to water technologies can make large, cost-effective improvements in water quality and treatment. This approach deionizes any fluid medium (including water) and is called herein the “Faraday DeIonizer” (FD). The FD process is a fundamentally orthogonal and scalable deionization technology (e.g., water desalination technology) that gains the following advantages when compared to such state-of-the-art ion separation technologies as reverse osmosis, distillation, and variants thereof:

FD can be at several times more energy-efficient;

FD can require less maintenance (can minimize fouling);

FD can have greater water throughput; and

FD can be more cost-effective.

FD can be implemented with any charged ionic species and in any fluid medium (gas, plasma, solutions, etc.).

This can decrease energy consumption; simplify design, construction, and operation of deionization systems; overcome biofouling; and provide sizeable improvements in the ability to process in-line any harmful ionic contaminants (e.g., heavy metals, radioactive elements, salt, water hardeners) from any fluid stream.

### BRIEF DESCRIPTION OF THE DRAWINGS

FIG. 1 illustrates use of ion selective membranes in FD;

FIG. 2 illustrates an exemplary embodiment of a rotating magnetic field system;

FIG. 3 illustrates another exemplary embodiment of a rotating magnetic field system; and

FIG. 4 illustrates a countercurrent flow scheme for on DI/reject channel pair.

### DETAILED DESCRIPTION

Desalting brackish water or seawater using such resent technologies as electrodialysis, reverse osmosis (RD), multistage flash distillation (MSF), and vapor compression requires intensive investments in capital and energy. Capital costs are high even for brackish water because of the operating conditions of high pressure (1000 psi=6.9 MPa) for RD, or high temperature and moderate pressure (266° F.=130° C. and 40 psi=276 kPa gauge) for MSF and vapor compression.

The amount of energy used by the present desalting of even brackish water is high relative to the minimum energy of separation of salt from seawater. The minimum free energy requirement for desalting seawater is 03.7 kWh/1000 gallons or 01.0 kWh/m3 at 25° C. A typical brackish water RO unit operates at 1000 psi (6.9 MPa) pressure, 30% water recovery, and 70% pump efficiency consumes 033 kWh/1000 gallons (08.7 kWh/m3). At an average retail cost of $0.10/kWh, just the energy costs for that method of removing the salt from brackish water would be $3.30/1000 gallons ($0.87/m³).

The Faraday Deionization Process

An innovative approach discussed below is based on the fusion of several technological advances. It takes any ionic species (dissolved minerals, radioactive elements, chromium, arsenic, salt, etc.) out of any fluid (brackish water, hard water, seawater, plasmas, gases, etc.). In the case of seawater desalination, FD is quite different than RO processes, which take purified water out of the salt solution. The FD process can remove dissolved ionic species or toxic chemicals from polluted water, or desalt seawater, with potentially several times less energy than state-of-the-art RO and at least 100 times less energy than seawater distillation. This new, energy-efficient process can be made possible by exploiting magnetics (Faraday's law), ion-selective membranes and/or porous walls, and can use energy recovery via net ionic currents in the separated fluidic streams.

The general process involves using a rotating magnetic field (generated by a permanent, electromagnet, and/or superconducting magnet) to generate a motive force (MF) on the positive and negative ions in the water to be treated. The generated MF results from Faraday's law. For the sake of convenience, water is used as the illustrative example; however, in principle, any fluidic medium can be used. The Faraday induced MF separates the positive ions from the negative ions. The water flows through a ductlike construct, and, with the Reynolds number less than 2000, the flow will be laminar in nature.

The mobilities of ions in water are typically quite low, ˜5×10⁻⁸ m² V⁻¹ s⁻¹. Therefore, the widths of the ducts will likely be limited to relatively small (centimeter or millimeter) size regimes to reduce the time required to separate the slow-moving ions. Furthermore, flows are preferably laminar on the input side, so the size of the flow channels should probably be small, e.g., 1 cm.

Methods by which to increase output generally include:

Increasing the number of flow channels;

Decreasing the distance the ions must travel;

Increasing the travel time of the ions; and

Increasing the flow velocity.

More specifically, these approaches can include:

Decreasing the channel width;

Increasing the channel length;

Adding more channels in parallel;

Increasing the magnetic field strength; and

Increasing the relative motion between the magnetic field and the ions.

In many cases, it may be desirable to use electromagnets instead of permanent magnets, because iron-core electromagnets can produce field strengths of 3-4 T (or even higher with special high-permeability magnetic steels) compared to the ˜1 T of permanent magnets.

Before beginning, we first briefly discuss ion selective membranes. Ion selective membranes allow the passage of either positively charged ions (cations) or negatively charged ions (anions) while excluding the passage of ions of the opposite charge. These semipermeable barriers are commonly known as ion-exchange, ion-selective, or electrodialysis membranes.

To avoid the long separation times due to the low ionic mobilities in water, we use a novel moving magnetic field that induces an MF based on the Faraday effect. If the channel is in a ring, a rotating magnet can move the lines of flux through stationary or slowly (e.g. laminar flowing liquid) fluid. Driven by a conventional 3600 rpm motor, a rotating magnet can give, e.g., a relative velocity between the magnetic field and ions in circular channel with a 1.5 meter circumference (a radius of about 9.4 inches) of about 90 meters/second, or about 360 times as fast. Thus the “last” ions might reach an exit wall in a little over 200 sec. The time could be proportionally reduced by increasing the magnetic field (e.g. by a factor of four to reduce the time to about 50 seconds), or by increasing the radius (e.g. by a factor of four), or both (for a factor of 16 reduction to about 13.6 seconds).

Traveling at 0.25 meters/second for 13.6 seconds, the fluid would travel about 5.4 meters. As the circumference of the increased radius above is six meters, a liquid traveling at the maximum velocity for laminar flow might be cleaned in a single pass. Alternately, flow could be slowed to about 0.06 meters per second and might be cleaned in a single pass around the smaller unit. One exemplary embodiment uses a channel width of about 3 to 5 mm and fluid flow rates in the 0.08 to 0.05 meters per second range. The fluid could also go fractional passes or multiple passes. The fluid could also go in a non-circular path, including, e.g. a linear path, with the lines of flux moving through the fluid to move oppositely charged ions in opposite directions. In a linear path, the path could pass through multiple rotating fields. If one wished, one might even do a double reversal of the direction of rotation and the direction of the magnetic field and maintain the same direction of ion separation. Fractional turns, e.g. half turns, can be convenient for units with more than one stage, and a unit could have a half turn first stage and a quarter turn second stage and a quarter turn third stage in the same rotating field.

An exemplary design utilizes a constant flow cross-section, but in some embodiments, the flow volume decreases as concentrated brine is removed or some fluid is recycled. Thus the input stage capacity might be about twice the output volume and the input flow velocity is twice the output flow velocity.

According to an exemplary embodiment, a method for deionizing a fluid comprises inputting fluid containing positive ions and negative ions in at least one channel, moving a magnetic field to provide relative motion between said magnetic field and said fluid containing positive and negative ions to cause positive ions in said channel to move toward a positive wall face and to cause negative ions in said channel to move toward a negative wall face, wherein positive ions are concentrated adjacent said positive wall face and negative ions are concentrated adjacent said negative wall face, removing at least a portion of said positive ions concentrated adjacent said positive wall face and at least a portion said negative ions concentrated adjacent said negative wall face, and retaining at least partially deionized fluid in said channels.

According to another embodiment, a method for deionizing a fluid comprises providing first, second, and third channels, providing a first hollow separating wall between said first channel and said second channel, and a second hollow separating wall between said second channel and said third channel, inputting fluid containing positive ions and negative ions in at least one channels, moving magnetic field to provide relative motion between said magnetic field and said fluid containing positive and negative ions to cause positive ions in said first channel to move toward said first wall and to cause positive ions in said second channel to move toward said second wall, and to cause negative ions in said second channel to move toward said first wall and to cause negative ions in said third channel to move toward said second wall, wherein positive ions are concentrated on a positive side of said first wall and negative ions are concentrated on a negative side of said first wall, and wherein positive ions are concentrated on a positive side of said second wall and negative ions are concentrated on a negative side of said second wall, allowing electrostatic attraction between said positive ions and said negative ions on said sides of said first hollow wall to cause said positive ions and said negative ions to pass into said first hollow wall and mix and form ion-concentrated fluid, and allowing electrostatic attraction between said positive ions and said negative ions on said sides of said second hollow wall to cause said positive ions and said negative ions to pass into said second hollow wall and mix and form ion-concentrated fluid, and allowing ion-concentrated fluid to exit said hollow walls and retaining at least partially deionized fluid in said channels.

This can also be a method of separating ions in a fluid, where an ion-containing fluid is stationary or moved at less than 1 meter per second and a magnetic field is moved through the fluid at more than 100 meters per second. This can also be a method of separating ions in a liquid, where an ion-containing liquid is stationary or moved at less than 0.25 meter per second and a magnetic field is moved through the fluid at more than 100 meters per second.

According to an exemplary embodiment, the magnetic field is rotating, and chambers with ion-containing fluid are stationary. In some embodiments, the magnetic field is provided by permanent magnets. In some embodiments, the magnetic field is electro-magnetically provided. In rotating electromagnetic embodiments, a stationary energizing coil may be used, and the rotating magnetic element may be laminated.

According to an exemplary embodiment, a pressure differential between the channels and inside the hollow walls and/or force from the relative motion between the ions and the magnetic field assist the causing of the ions to pass into the walls.

According to an exemplary embodiment, a method of magnetic de-ionization using multiple channels with hollow separator walls can include providing first, second, and third channels, providing a first hollow separating wall between the first channel and the second channel, and a second hollow separating wall between the second channel and the third channel, inputting fluid containing positive ions and negative ions in the at least three channels; using said fluid containing positive and negative ions and a magnetic field to cause positive ions in the first channel to move toward the first wall and to cause positive ions in the second channel to move toward the second wall, and to cause negative ions in the second channel to move toward the first wall and to cause negative ions in the third channel to move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall, forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid, forcing negative ions from the third channel to pass through the second wall negative face into the second hollow wall and forcing positive ions from the second channel to pass through the second wall positive face into the second hollow wall, wherein the positive and negative ions mix in the second hollow wall and form ion-concentrated fluid. The force that forces ions through the first wall faces is supplied by movement of ions relative to a magnetic field and at least one of a channel pressure that is higher than pressure in the first hollow wall and electrostatic attraction between the positive ions adjacent a positive face of the first wall and negative ions adjacent a negative face of the first wall, and the force that forces ions through the: second wall faces is supplied by movement of ions relative to a magnetic field and at least one of a channel pressure that is higher than pressure in the second hollow wall and electrostatic attraction between the positive ions adjacent a positive face of the second wall and negative ions adjacent a negative face of the second wall. The method can further include allowing ion-concentrated fluid to exit the hollow walls, and retaining at least partially deionized fluid in the channels.

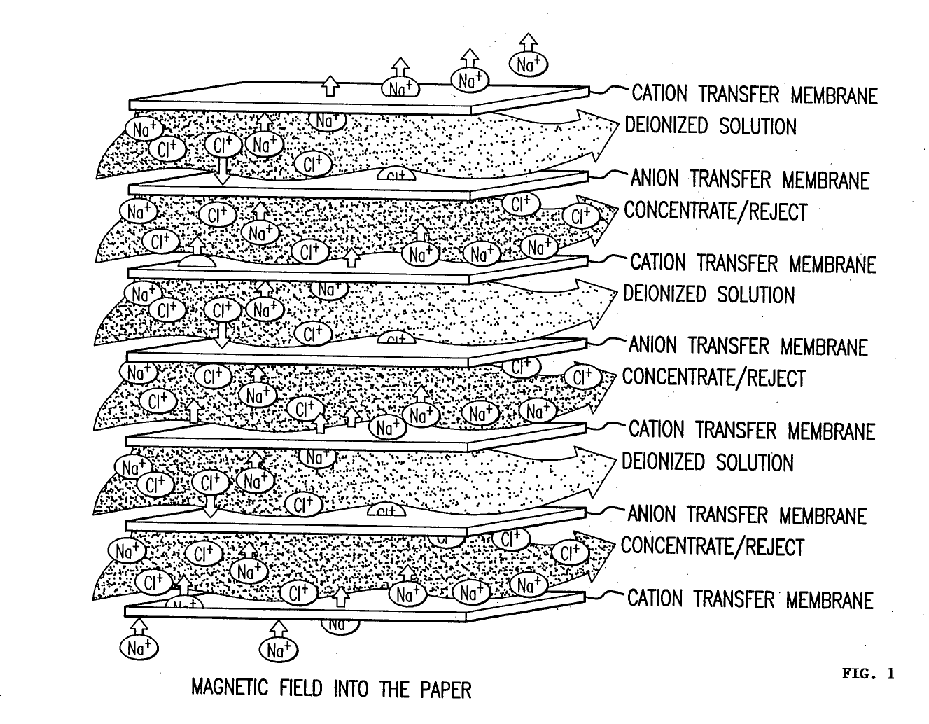

As shown in FIG. 1, a method of de-ionization using ion-selective membranes can include at least partially removing both anions and cations from a fluid by providing first, second, and third channels, providing a first hollow separating wall between the first channel and the second channel, and a second hollow separating wall between the second channel and the third channel, inputing fluid containing positive ions and negative ions in the at least three channels, using said fluid containing positive and negative ions and a magnetic field to cause anions and cations to separate, such that positive ions in the first channel move toward the first wall and positive ions in the second channel move toward the second wall, and negative ions in the second channel move toward the first wall and negative ions in the third channel move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall; forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid, forcing negative ions from the third channel to pass through the second wall negative face into the second hollow wall and forcing positive ions from the second channel to pass through the second wall positive face into the second hollow wall, wherein the positive and negative ions mix in the second hollow wall and form ion-concentrated fluid. The force that forces ions through the first wall faces is supplied by at least one of, movement of ions relative to a magnetic field, a channel pressure that is higher than pressure in the first hollow wall, and electrostatic attraction between the positive ions adjacent a positive face of the first wall and negative ions adjacent a negative face of the first wall, and the force that forces ions through the second wall faces is supplied by at least one of, movement of ions relative to a magnetic field, a channel pressure that is higher than pressure in the second hollow wall, and electrostatic attraction between the positive ions adjacent a positive face of the second wall and negative ions adjacent a negative face of the second wall. At one of least of said wall faces is a ion-selective membrane. The method can further include allowing ion-concentrated fluid to exit the hollow walls and retaining at least partially deionized fluid in the channels.

The use of a moving magnetic field, where the magnetic field moves hundreds of times faster than the maximum, laminar-flow-restricted, fluid movement, allows the size of the unit to be dramatically reduced. The use of multiple channels with hollow separator walls, where after oppositely charged ions are magnetically moved to opposite faces of a wall, the ions are mutually attracted in through opposite faces of the wall and remixed, allows the rapid removal of ions, avoiding the building up a large, separation-retarding, Hall voltage. The combination of a moving magnetic field and multiple channels with hollow separator walls provides the first truly practical magnetic de-ionization technique. The use of ion-selective membranes, where removal of fluid with lower-than average content of at least one type of ion is generally avoided, allows the effectiveness of ion removal to be greatly increased.

In most embodiments, the fluid in the channels flows at a velocity such that the flow is laminar and turbulent flow is avoided. In some embodiments the fluid in the chambers is stationary.

In one embodiment there are two end channels and at least seven interior channels and at least partially deionized fluid from said interior channels is used as product, and fluid from said end channels is recycled. In an alternate embodiment, channels are assembled into a cylinder about an axis with an equal number of channels and walls, such that walls without channels on both sides are avoided.

In some embodiments, ion-selective membranes are used on one side of the walls and porous partitions are used on the other. In other embodiments, ion-selective membranes are used on both sides of the walls and a sweep fluid is used within the walls. The sweep fluid may be of the same type of fluid input into the channels. The sweep fluid may be a portion of fluid output from the channels, which may be run as a counter-flow sweep. In some embodiments, air-core electromagnets, including superconducting magnets may be used.

In some embodiments, ion-selective membranes are used on both sides of the walls, a sweep fluid is used within the walls in a first stage, and at least one later stage uses ion-selective membranes on one side of the walls and :porous partitions on the other.

Porous partitions, e.g., porous membranes or ricer shaped partitions, can be used on one or both sides of the walls. An ion-selective membrane may be used on at least one side.

In some embodiments the fluid containing positive ions and negative ions is saline water. In some embodiments the fluid containing positive ions and negative ions is brackish water. In some embodiments the fluid containing positive ions and negative ions is seawater water. In some embodiments the fluid containing positive ions and negative ions is ion-containing gas. In some embodiments the fluid containing positive ions and negative ions is nuclear waste.

In some embodiments the fluid containing positive ions and negative ions is deionized and potable water is produced. In some embodiments the fluid containing positive ions and negative ions is partially deionized and further processed by reverse osmosis and potable water is produced.

In some embodiments, more than one stage of de-ionization is used and the ion-concentrated fluid exiting a later stage is recycled to an earlier stage.

Electromagnets can be used instead of permanent magnets, as iron or steel core electromagnets can give 3 to 4 tesla (and more with special high-permeability magnetic steels), compared to the ˜1 tesla of permanent magnets. The size reduction can lead to enough net cost reduction to out-weigh the minor operating cost of an electromagnet.

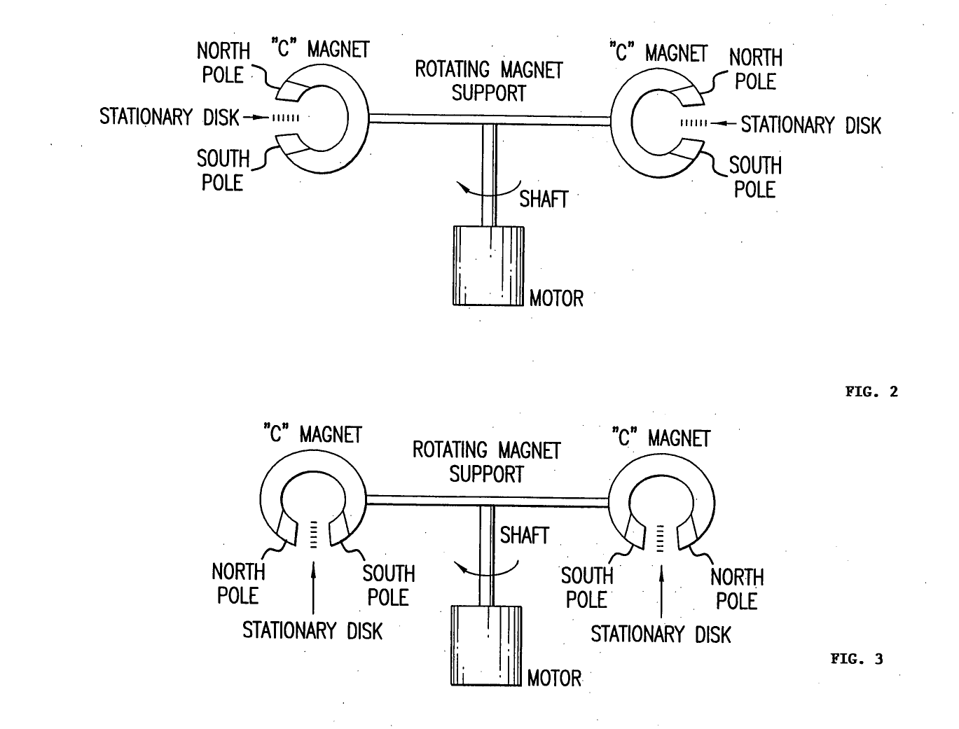

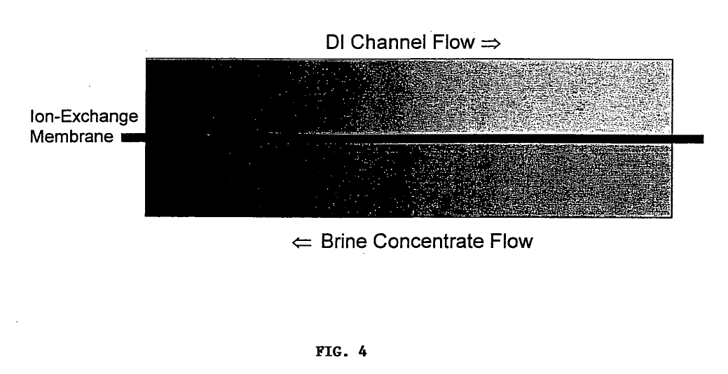

The magnets can be visualized as “C” magnets (akin to horseshoe magnets). The gap in the C's could go radially out from a rotating shaft as shown in FIG. 2, and this configuration is convenient for stages one-half arc or less. For ease of fabrication, configurations having the gap in the C's parallel to the shaft may be used, and a configuration with the gap pointing down is shown in FIG. 3. A portion of the C magnets could be stationary, but the eddy current losses are generally minimized if the entire C rotates, and it both has lower losses and is cheaper to build if it's all laminated. A circle of electromagnet laminations with a stationary coil can be used in place of permanent magnets in a similar configuration.

Laminating into a circle requires that either the laminations or the spacers between the laminations, or both, be wedge shaped. Wedged shaped spacers can be plastic and are generally easier to make than wedge shaped metallic portions. The rotating magnetic field may possibly also be supplied by a multi-phase (e.g. 3-phase or 2-phase) motor-stator configuration where the field is magnetically biased to not reverse across the gap. Such a configuration might eliminate moving magnetic parts.

Magnet poles, electromagnet or permanent magnet, of a rotating magnet may be laminated at least as deep as the gap between north and south poles, e.g., about 1 cm. The laminations should be spaced far enough apart to keep flux lines from jumping from one lamination to the next, e.g., about one mm. The ions may remix in the hollow walls with brine exiting, flowing parallel to the magnetic line of flux, minimizing the separation of ions in hollow walls and reducing the load on a motor that drives the rotation. A separation of ions in the hollow walls can, however, help transfer additional ions into the hollow walls.

While the ring of channels could be rotated and the magnet C's held stationary (as the flow might remain laminar as long as the fluid is moving relatively slow in relation to the channels), such a configuration is more complicated than having the ring stationary and moving the magnets.

Wall Effects in FD

One of the many unique features of the FD process is the effect of the walls of the duct. In electrostatic ionic separation processes, the ions are attracted to the wall, and they are absorbed onto the wall (high-surf ace-area electrode). Once absorbed, desorbing the ions from the electrode surface is a technical challenge. Similarly, in a magnetically-driven separation process, the ions are magnetically forced to the wall. However, the separated ions are not absorbed onto the duct walls, but are instead relatively free to pass through the walls if conditions are right.

In any event, the wall is not the ion collection portal. The ions are collected in ancillary concentrated/reject ports. For the FD process, the wall need not be composed of impermeable materials to absorb the ions nor to impede their relative motion. The walls of the duct can be formulated as:

Porous membranes on both sides (with relatively large pore sizes to allow ions to pass through, but to provide some flow resistance to the fluidic media);

An ion-permeable membrane on one side and a porous membrane on the other;

Different ion-selective permeable membranes on both sides of the duct, with one side anion-selective and the other cation-selective.

If the ions are removed almost as soon as they reach the walls, and their movement is very slow, then the ion distribution across most of the channel will be almost flat and will remain almost flat as the solution becomes more dilute as purification continues; the only major increase in ion density would be at the walls. An important element is forcing the ions to flow from a region of lower concentration within the channel to a region of higher concentration within the wall. The forces tending to make the ions flow into the wall include (1) the action of the generated EMF via the rotating magnetic field upon the ions, (2) the net electrostatic attraction from the counterions across or within the wall, and (3) a somewhat lower pressure within the wall that partially offsets the concentration gradient.

The phenomena above can limit the degree of practical purification achieved per stage. For example, if ions will only flow at practical speeds into a fluid with 0.2 molar (M) higher concentration, then the waste stream from a 0.6-M input could be 0.8 M. The waste stream from a 0.4-M input stage could be 0.6 M, or equal to the original input stream. Therefore, the first stage can go from 0.6 M to 0.4 M while the increased-concentration waste stream is discarded. The second stage could go from 0.4 M to 0.2 M while the increased-concentration waste stream is recycled back to the first stage. The third stage could go from 0.2 M to 0.05 M while the increased-concentration waste stream is recycled back to the second stage.

Preliminary Energetics of FD

The energetics of the FD system, in principle, should be quite low for a number of reasons. First, FD removes the charge-carrier solutes from the solution rather than the solvent from the solution. That is, FD removes minority constituents, not the majority constituent. (Reverse osmosis removes the solvent.)

Second, the high ion concentration reject ports are not only concentrated in ions, but because of the ion-separation process, they are also rich in one type of ion. Therefore, as the fluid flows in these reject ports, it conducts an ionic current. This ionic current can be recovered to further improve the energy efficiency of the FD process. The cation-rich and anion-rich ionic currents can be connected to an external load (e.g., capacitor plates).

Examinations of the FD process reveal a novel energy-recovery process available for exploitation: ionic current in the reject ports.

Third, the energetics of FD do not violate the enthalpy of solution. Dissolving a solute involves three processes, (1) breaking ionic forces, (2) expanding the solvent cage, and (3) stabilizing the ions. Each of these steps has an associated enthalpy change (ΔH): ΔHₛₒₗᵤₜₑ, always positive; ΔHₛₒₗᵥₑₙₜ, always positive, and ΔH_{mixing}, always negative. The heat of solution (ΔHₛₒₗᵤₜᵢₒₙ) is the sum of these three terms. FD does not involve breaking ionic forces, stabilizing ions, nor expanding the solvent cage. It is a process that simply separates the ions already in the solution into regions of relatively higher and lower concentrations, but never takes them out of solution. Therefore, the process requires relatively low energy.

Also, if permanent magnets (which can provide ˜1 T of magnetic flux) are used, the embodiments of FD use a minimal amount of external energy. The sources of external energy include a pump to move the water and an external motor to rotate the magnetic field as shown in FIG. 1. The pumps probably should provide only 50-100 psi (340-690 kPa) of pressure, which is very small in comparison to that used in RO systems, 800-1000 psi (5.5-6.9 MPa). This being the case, it is reasonable to assume that some energy costs and usage are directly proportional to applied pressure (FD=50-100 psi, RO=800-1000 psi); therefore, such energy costs can be reduced by factors of ˜10× over RO. If superconducting magnets are used, the operational costs will increase somewhat because liquid nitrogen or helium would have be supplied to the magnets periodically. Efficiency would also improve, so the type of magnet chosen should be subjected to a cost-benefit analysis. Since motors are ˜90% efficient to rotate, the energy use of this configuration is estimated to be low.

FD Attributes

The FD water purification technology has the following attributes:

It can require little or no water pretreatment.

In principle, it has very low energy consumption and incorporates energy recovery.

It does not require the use of harmful chemicals.

It has minor logistics issues for deionization operation.

Its total costs (capital plus operating) are estimated to be highly cost-effective per unit of flow. Since the water pressures used can be relatively low, 50-100 psi (340-690 kPa), low-cost plumbing and seals can be used. This is not the case with high-pressure RO systems.

It is a simple design.

It is simple to operate.

It can remove any charged species from any fluid medium.

In principle, it can be constructed without membranes subject to fouling.

Its design can be applied on many scales.

It can purify water of any charged or chargeable contaminant, including both biological (viruses, bacteria), and chemical (radioactive nuclides) species.

Integration of FD and RO Technoloeies

An optimal solution to the desalination and purification of aqueous solutions may involve a hybrid approach that combines the FD and RO technologies. For example, FD could be used upstream of an RO unit. This would significantly reduce the duty requirements on both systems in handling copious amounts of total dissolved solids; therefore, it could reduce the total energy consumption of the integrated hybrid system. Likewise, because FD is better able to handle radioactive elements and heavy metals, with the additional benefit of being able to dispose of them in a safer manner during a concentrated discharge process, it can improve the effectiveness of a downstream RO unit. An upstream FD could also be used to significantly reduce the salt concentration in saltwater feeding into an RO unit, in which case the water flux through the RO membranes will increase substantially because the concentration polarization of salt near the membrane surface is reduced, leading to an overall more efficient system. Besides the possibility of having a FD feed into an RO system, a FD could also be used to feed into a forward or direct osmosis (FO) configuration.

According to exemplary embodiments, a new way to deionize any fluid medium based on the Faraday Effect. The basic elements can include:

(1) The use of Faraday induced MF forces to separate the charged species from any fluid.

(2) Methods to separate the regions of high ion concentration from those of lower ion concentration in the flow using:

(a) Porous partitions;

(b) Ion-selective membranes; and/or

(c) Variations thereof.

(3) Methods for energy recovery in the process that exploit using the discharged ionic current that is comprised of mostly one ionic species.

Thus, according to exemplary embodiments, there are three major desalt mechanisms that make magnetically ion separation practical.

First, multiple channels with hollow separator walls may be used. After oppositely charged ions are magnetically moved to opposite faces of a wall, the ions are mutually attracted in through opposite faces of the wall and remixed, and thus the rapid removal of ions avoids building up a large, separation-retarding, Hall voltage.

Second, ion-selective membranes may be used. An ion-selective membrane allows removal of ions of one type, while avoiding the counter-productive removal of fluid with lower-than average content of the other type of ion, thus the effectiveness of ion removal is greatly increased.

Third, a moving magnetic field may be used. The magnetic field moves hundreds of times faster than the maximum, laminar-flow-restricted, fluid movement, and the size of the unit is dramatically reduced.

In some cases, the process also uses the ability for energy recovery of the separated ions that form an “ionic current” that can be harvested to operate ancillary devices, or be feed back into the rotating motors, pumps, etc.

During the first stage of magnetic purification, the use of a pair of ion selective membranes (one positive selecting and one negative selecting) on the sides of a hollow wall and a sweep stream within the wall can give a high ion extraction rate. The combination of magnetic field induced molarity buildup at the wall and mutual attraction of ions on opposite faces provides force that could transfer ions through the pair of ion selective membranes into the sweep fluid that has, e.g., a 0.15 to 0.20 higher molarity than the process fluid. However, an additional 0.05 to 0.10 rise is available from the 100 to 200 psi higher pressure of the process fluid compared to the waste stream, and thus the ions can be transferred into a higher molarity sweep stream, with, e.g., a total of 0.20 to 0.30 molarity rise, or even 0.40 with 400 psi. The molarity rise of waste above the process fluid is also the amount the process fluid can be reduced in that stage, thus the first stage can reduce the molarity of the process stream from, e.g., the 0.4 of brackish water to a 0.2 or 0.1 stream. Similarly, the 0.6 of seawater can be reduced to a 0.4 or 0.3 or even a 0.2 stream.

Further stages of magnetic purification can use one ion selective membrane and a porous partition as sides of the wall. Ion buildup on opposite sides wall from the combination of ion movement due to magnetic forces and mutual attraction of ions on opposite faces provide ion buildup to give a recycle stream of at least a 0.15 to 0.20 higher molarity than the average process fluid in the waste fluid stream. Fluid is transferred through a porous partition on one side while combination of molarity buildup at the wall, and mutual attraction of ions on opposite side of ion selective membrane, provide force to transfer ions through the ion selective membrane.

One can alternately use part of output as recycle in a counterflow flush in the further stages and pump the recycle back into the inlet and use sets of opposite ion selective membranes throughout (a flush of saline of the same salinity as input saline, would still be used for stage I). If flowing opposite direction to main flow, ions in recycle will tend to move in a direction to pull ions through the membranes, but flow may be turbulent in the recycle stream.

### EXAMPLE 1

### Stage I, Saline Sweep Waste Stream

input pressure 200 psi,

input molarity; 0.4 molar (brackish water)

waste molarity; up to ˜0.1 above that of input saline

process fluid to waste, molarity rise: low at entrance, 0.3 max

product stream molarity; goes from 0.4 to 0.1

output molarity; 0.1 molar

uses 2 ion selective membranes

process fluid volume out of Stage I is only slightly less than the Stage I process volume

input, and sweep volume may be between 5 and 20 times the product volume

### STAGE II OF EXAMPLE 1

### Reverse Osmosis, Booster Pump to 400 psi

input molarity; 0.1 molar input

waste molarity; about 0.2

product stream; goes from 0.1 molarity to <500 ppm

output; <500 ppm

uses RO membranes

product volume=½ of RO input volume

Example 1 notes: Uses 2 ion selective membranes. Uses a saline sweep of same salinity as the input saline, and a sweep flow of between 5 and 20 times the product flow. Product fluid volume out is about 50% of the volume in Stage I, thus the first stage needs to have 2 times the capacity of product output.

### EXAMPLE 2

### Stage I, With Saline Sweep Waste Stream

input molarity; 0.4 molar input

waste molarity; barely above that of input saline

molarity rise: initially −0 goes up to 0.2 rise at stage end

product stream molarity; goes from 0.4 to 0.3

output molarity; 0.3 molar output

uses, e.g., 2 ion selective membranes

### EXAMPLE 2

### Stage II, Exhaust Stream Recycled to Stage I

input molarity; 0.3 molar input

recycle molarity; goes from 0.45 to 0.35 (average 0.4)

molarity rise: 0.15 rise

product stream molarity; goes from 0.3 to 0.2

output molarity; 0.2 molar output

uses, e.g., 1 ion selective membrane and one porous partition

recycle=50% of its input volume

### EXAMPLE 2

### Stage III, Exhaust Stream Recycled to Stage II

input molarity; 0.2 molar input

recycle molarity; goes from 0.35 to 0.25 (average 0.3)

molarity rise: 0.15 rise

product stream molarity; goes from 0.2 to 0.1

output molarity; 0.1 molar output

uses, e.g., 1 ion selective membrane and one porous partition

recycle=50% of its input volume

### EXAMPLE 2

### Stage IV, Exhaust Stream Recycled to Stage III

input molarity; 0.1 molar input

recycle molarity; about 0.25 to −0.15 (average −0.2)

molarity rise: about 0.15

product stream; goes from 0.1 molarity to <500 ppm

output; <500 ppm [˜0.009 molar]

uses, e.g., 1 ion selective membrane and one porous partition

recycle=50% of its input volume

Example 2 notes: The first stage needs to have a volume capacity of 8 times the product volume. Example 2 has almost the same product output as new saline in, and thus avoids doing any extra pretreatment to the fluid. Example 2 uses more relaxed requirements for molarity rise than example 1, and thus reduces needed residence time in the field and further reduces Hall voltage effects. Note also that the ion drift velocity near the porous partition can be the same order of magnitude as the velocity of the flow through the partition, but velocity of flow is much smaller near the opposite wall.

### EXAMPLE 3

### Stage I, Saline Sweep Waste Stream

input pressure 220 psi

input molarity; 0.4 molar input

waste molarity; barely above that of input saline

molarity rise: ˜0 goes up to 0.1 rise at stage end

product stream molarity; goes from 0.4 to 0.3

output molarity; 0.3 molar output

uses, e.g., 2 ion selective membranes

### EXAMPLE 3

### Stage II, Exhaust Stream Recycled to Stage I

input molarity; 0.3 molar input

recycle molarity; goes from 0.45 to 0.35 (average 0.4)

molarity rise: 0.15 rise

product stream molarity; goes from 0.3 to 0.2

output molarity; 0.2 molar output

uses, e.g., 1 ion selective membrane and one porous partition

### EXAMPLE 3

### Stage III, Exhaust Stream Recycled to Stage II

input molarity; 0.2 molar input

recycle molarity; goes from 0.35 to 0.25 (average 0.3)

molarity rise: 0.15 rise

product stream molarity; goes from 0.2 to 0.1

output molarity; 0.1 molar output

uses, e.g., 1 ion selective membrane and one porous partition

### EXAMPLE 3

### Stage IV, Exhaust Stream Recycled to Stage III

input molarity; 0.1 molar input

recycle molarity; about 0.25 to ˜0.15 (average 0.2)

molarity rise: about 0.15

product stream molarity; goes from 0.1 to 0.05

output molarity; 0.05 molar output

uses, e.g., 1 ion selective membrane and one porous partition

### EXAMPLE 3

### Stage V, Reverse Osmosis at Pressure of 200 psi

input molarity; 0.05 molar input

waste molarity; about 0.1

product stream; goes from 0.05 molarity to <500 ppm

output; <500 ppm

uses RO membranes

product volume=½ of RO input volume

Example 3 notes: Example 3 is similar to example 2, but uses a low pressure RO polishing at the end.

### EXAMPLE 4

### Stage I, Seawater Input and Sweep

input pressure 400 psi,

input molarity; 0.6 molar (seawater)

waste molarity; up to ˜0.1 above that of input saline

molarity rise: up to 0.4 rise

product stream molarity; goes from 0.6 to 0.2

output molarity; 0.2 molar

uses 2 ion selective membranes

process fluid volume out of Stage I is only slightly less than the Stage I process volume

input, and sweep volume may be between 5 and 20 times the product volume

### EXAMPLE 4

### Stage II, Reverse Osmosis, Booster Pump to 500 psi

input molarity; 0.2 molar input

waste molarity; about 0.25

product stream; goes from 0.2 molarity to <500 ppm

output; <500 ppm

uses RO membranes

product volume=⅕ of RO input volume, ˜⅕ of input volume

Example 4 notes: Example 4 is a higher pressure system (although still much lower than a conventional RO system). It is also for seawater, rather than brackish water.

### EXAMPLE 5

### Stage I, Saline Sweep Waste Stream

input molarity; 0.6 molar seawater input

waste molarity; barely above that of input seawater

molarity rise: ˜0 goes up to 0.4 rise at stage end

product stream molarity; goes from 0.6 to 0.4

output molarity; 0.4 molar output

uses, e.g., 2 ion selective membranes

### EXAMPLE 5

### Stage II, Counterflow Stream Recycled to Stage I

input molarity; 0.4 molar input

recycle molarity; goes from 0.1 at exit to 0.6 (recycle=0.6)

molarity rise: 0.2 rise

product stream molarity; goes from 0.4 to 0.1

output molarity; 0.1 molar output

uses, e.g., 2 ion selective membranes

recycle volume=50% of volume (stages I and II have about the same volume)

### EXAMPLE 5

### Stage III, Reverse Osmosis at Pressure of 300 psi

input molarity; 0.1 molar input

waste molarity; about 0.15

product stream; goes from 0.1 molarity to <500 ppm

output; <500 ppm

uses RO membranes

product volume=½ of RO input volume

Example 5 notes: Example 5 has a seawater input, has counterflow recycling, and uses a moderate-pressure RO polishing at the end.

Performance improvements using a counterflow sweep (or, equivalently, a countercurrent flow) design may be derived through a reduction in osmotic pressure differentials across the membranes. In a parallel, concurrent flow scheme, the lowest ionic strength DI solution (e.g., the “cleanest” portion of the product water stream) is immediately adjacent to the highest ionic strength concentrate solution (e.g., the “dirtiest” portion of the reject water stream). The osmotic pressure difference across the ion-exchange membranes is maximized under such circumstances, thereby tending to cause water from the low ionic strength side to diffuse across the membrane to the high ionic strength side. In such cases there is a clear loss of “clean” water product to the reject stream, with concomitant losses in product rate and energetic efficiency.

Example:

Assume that the input solution for the DI (C_{0,DI}) and reject streams (C_{0,brine}) are identical: idealized seawater (dissolved NaCl at a concentration of 35,000 ppm) at 30° C. The concentration difference across the membrane at the input (beginning) of the flow channels in a parallel, concurrent flow scheme is 0 ppm (δC_{i, DI/brine}=0 ppm). Total fluid flow in each stream is the same (e.g., Q_{DI}=Q_{brine}). Salinity in the DI stream is brought down to the potable water target of 500 ppm dissolved salt (C_{f, DI}); given that all of the salt removed from the DI stream is deposited into the reject stream, the end of the reject stream must contain 69,500 ppm of dissolved salt (C_{f, brine}=69,500 ppm). Therefore, the concentration difference across the membrane at the end of the flow channels in a parallel, concurrent flow scheme is 69,000 ppm (δC_{f, DI/brine}=69,000 ppm).

Osmotic pressure differences across a membrane may be expressed as a function of the difference in solution concentration according to the following:

δπ=δ(n/V)RT=δMRT

where δπ is the osmotic pressure difference, δ(n/V) is the difference in solute molarity across the membrane (n/V is the quantity moles per liter, or molarity, M), R is the ideal gas constant (0.0821 L atm mol⁻¹ K⁻¹, and T is the absolute temperature (303 K in this example).

At 30° C.:

δπ_{f}=δM_{f}RT=δ(C_{f, DI/brine})(MW_{NaCl})(0.0821 L atm mol⁻¹ K⁻¹)(303K)

δπ_{f}≈29 atm (approx 420 psi) {δπᵢ=0, since δC_{0, DI/brine}=0 ppm}

Such a differential pressure would be expected, in many cases, to cause “clean” water to permeate through the ion-selective (or ion-exchange) membranes into the reject stream. The slower the flow rates in each channel, the greater the potential for loss.

In a countercurrent flow scheme, depicted in FIG. 4 for one DI/reject channel pair, the osmotic pressure across the membrane at the product end is reduced by 50% as in the following discussion.

Using the same DI and reject stream sources (35,000 ppm seawater at 30° C.) in a countercurrent flow design produces the following values by analogous reasoning:

C_{0,DI}=C_{0,brine}=35,000 ppm;

C_{f, DI}=500 ppm; C_{f, brine}=69,500 ppm.

However, the concentration difference at the product end of the countercurrent flow scheme (right-hand side in Figure) is substantially half of what it was before, as the lowest ionic strength DI product (C_{f, DI}=500 ppm) is adjacent to the lowest ionic strength reject stream (C_{0,brine}=35,000 ppm).

δπ_{product end}=δM_{product end}RT=δ(C_{product end})(MW_{NaCl})(0.0821 L atm mol⁻¹ K⁻¹)(303K)

δπ_{productend}≈14.5 atm (approx 210 psi) {δπ_{source end} is also 14.5 atm}

This 50% reduction in osmotic pressure across the membrane, for the simple example given, would be expected to significantly reduce system losses due to osmotic pressure-induced water permeation through the ion-selective membranes.

It should be understood that the foregoing description and accompanying drawings are by example only and are not intended to limit the present invention in any way. A variety of modifications are envisioned that do not depart from the scope and spirit of the invention.

What is claimed is:

1. A method for deionizing a fluid, comprising:
inputting fluid containing positive ions and negative ions into a channel with a positive wall and a negative wall;
removing at least a portion of said positive ions through said positive wall and at least a portion said negative ions through said negative wall using force supplied by at least one of, movement of ions relative to a magnetic field, a channel pressure that is higher than pressure outside said positive and negative walls; and
retaining at least partially deionized fluid in said channel.

2. The method of claim 1, wherein said positive wall is an anion-selective membrane and said negative wall is a cation-selective membrane and a sweep fluid is used outside of the walls.

3. The method of claim 2, wherein the sweep fluid is of the same type of fluid input into the channels.

4. The method of claim 1, wherein the sweep fluid is a portion of fluid output from the channels.

5. The method of claim 4, wherein the sweep fluid is run as a counterflow sweep.

6. The method of claim 5, wherein more than one stage of de-ionization is used and the ion-concentrated fluid exiting a later stage is recycled to an earlier stage.

7. The method of claim 6, wherein the difference between the channel and the sweep fluid molarity is about 1.5 in at least one stage.

8. The method of claim 2, wherein the sweep fluid is a portion of fluid output from the channels, wherein the sweep fluid is run as a counterflow sweep, wherein more than one stage of de-ionization is used and the ion-concentrated fluid exiting a later stage is recycled to an earlier stage, and wherein the difference between channel and sweep fluid molarity is about 1.5 in at least one stage.

9. A method for deionizing a fluid, comprising:
inputing fluid containing positive ions and negative ions in at least one channel;
moving a magnetic field to provide relative motion between said magnetic field and said fluid containing positive and negative ions to cause positive ions in said channel to move toward a positive wall face and to cause negative ions in said channel to move toward a negative wall face, wherein positive ions are concentrated adjacent said positive wall face and negative ions are concentrated adjacent said negative wall face;
removing at least a portion of said positive ions concentrated adjacent said positive wall face and at least a portion said negative ions concentrated adjacent said negative wall face; and
retaining at least partially deionized fluid in said channels.

10. A method for at least partially removing both anions and cations from a fluid, comprising: providing first, second, and third channels;
providing a first hollow separating wall between the first channel and the second channel, and a second hollow separating wall between the second channel and the third channel;
inputing fluid containing positive ions and negative ions in the at least three channels; forcing negative ions from the second channel to pass through the first wall negative into the first hollow wall and forcing positive ions from the first channel to pass through the first wall positive into the first hollow wall, wherein the positive and negative ions mix in the first hollow wall;
forcing negative ions from the third channel to pass through the second wall negative into the second hollow wall and forcing positive ions from the second channel to pass through the second wall positive into the second hollow wall, wherein the positive and negative ions mix in the second hollow wall; wherein force that forces ions through the first wall is supplied by at least one of, movement of ions relative to a magnetic field, a channel pressure that is higher than pressure in the first hollow wall, and electrostatic attraction between the positive ions adjacent a positive face of the first wall and negative ions adjacent a negative face of the first wall, and wherein force that forces ions through the second wall faces is supplied by at least one of, movement of ions relative to a magnetic field, a channel pressure that is higher than pressure in the second hollow wall, and electrostatic attraction between the positive ions adjacent a positive face of the second wall and negative ions adjacent a negative face of the second wall;
wherein at one of least of said wall faces is a ion-selective membrane;
allowing ion-concentrated fluid to exit the hollow walls; and,
retaining at least partially deionized fluid in the channels.

11. The method of claim 1, wherein fluid from the first channel is input into said second channel, and wherein fluid from the second channel is input into said third channel.

12. A method for at least partially removing both anions and cations from a fluid, comprising: providing first, second, and third channels;
providing a first hollow separating wall between the first channel and the second channel, and a second hollow separating wall between the second channel and the third channel;
inputing fluid containing positive ions and negative ions in the at least three channels; using said fluid containing positive and negative ions and at least one of a magnetic and a electrostatic field cause anions and cations to separate, such that positive ions in the first channel move toward the first wall and positive ions in the second channel move toward the second wall, and negative ions in the second channel move toward the first wall and negative ions in the third channel move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall;
forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid;
forcing negative ions from the third channel to pass through the second wall negative face into the second hollow wall and forcing positive ions from the second channel to pass through the second wall positive face into the second hollow wall, wherein the positive and negative ions mix in the second hollow wall; and form ion-concentrated fluid; wherein force that forces ions through the first wall faces is supplied by at least one of, movement of ions relative to a magnetic field, a channel pressure that is higher than pressure in the first hollow wall, and electrostatic attraction between the positive ions adjacent a positive face of the first wall and negative ions adjacent a negative face of the first wall, and wherein force that forces ions through the second wall faces is supplied by at least one of, movement of ions relative to a magnetic field, a channel pressure that is higher than pressure in the second hollow wall, and electrostatic attraction between the positive ions adjacent a positive face of the second wall and negative ions adjacent a negative face of the second wall; wherein at one of least of said wall faces is a ion-selective membrane;
allowing ion-concentrated fluid to exit the hollow walls; and,
retaining at least partially deionized fluid in the channels.
